(19) United States
(12) Patent Application Publication
(10) Pub. No.: US 2015/0229727 A1
(43) Pub. Date: Aug. 13, 2015

(54) SYSTEM AND METHOD FOR PROVIDING REAL-TIME, LOCATION-DEPENDENT ENTERTAINMENT

(71) Applicants: Frank-Rene Schäfer, Kerpen-Horrem (DE); Axel Torschmeid, Köln (DE); Matthias Koch, Montigny Le Bretonneux (FR); Tina Friedrich, Köln (DE)

(72) Inventors: Frank-Rene Schäfer, Kerpen-Horrem (DE); Axel Torschmeid, Köln (DE); Matthias Koch, Montigny Le Bretonneux (FR); Tina Friedrich, Köln (DE)

(21) Appl. No.: 14/622,060

(22) Filed: Feb. 13, 2015

(30) Foreign Application Priority Data
Feb. 13, 2014 (DE) 10 2014 101 785.4

(51) Int. Cl. H04L 29/08

(52) U.S. Cl. CPC H04L 67/18; H04L 67/12

(57) ABSTRACT

A system and method for providing real-time, location-dependent entertainment are disclosed herein. The system includes a location receiver to receive a position associated with an object, the object being a moving vehicle; a data receiver to receive location-dependent data based on the position via a data bank; an input receiver to receive an input from an operator in the object; a data transmitter to transmit the received input to a server associated with the data bank. The server is configured to provide receive the input, and process an answer; and a data receiver to receive the answer.

### CROSS-REFERENCE TO RELATED APPLICATIONS

This U.S. patent application claims priority to German Patent Application No. 10 2014 101 785.4, filed Feb. 13, 2014 entitled “A SYSTEM FOR PROCESSING DATA, AS WELL AS A METHOD FOR OPERATING THE SYSTEM,” the entire disclosure of the application being considered part of the disclosure of this application and hereby incorporated by reference.

### BACKGROUND

In motor vehicles, a driver or passenger may give attention to more than performance, fuel consumption, external appearance, or the comfort of the inside atmosphere. For example, the driver or passenger may also pay attention to operating optional equipment, such as operations for identifying the surroundings, adjustments based on the driving situation, entertainment, and navigation.

On longer trips, monotonous tasks and repetitive actions of the driver when driving the vehicle require increased attention and concentration. But the boredom is countered by additional vehicle information systems. For example, one of the vehicle information systems may transmit information about areas being driven through, provide games, etc. As a result, attention to driving, and traffic conditions may be improved. However, the games and activities may also become repetitive.

In one example, a device is provided to integrate an existing vehicle link to a computer unit for a trip information system. The system provides the driver and/or the passengers with information and entertainment at a low operating cost. The trip information output, which is visual or audible, is dependent on the geographic position of the vehicle or the vehicle's situation. The output of the system involves a set of geographic marks referring to the geographic position of the vehicle. At the same time, the information can be of various categories, such as nearby sights, oceans, rivers, gas stations, traffic jams, hotels, restaurants, business locations, or the like. The data is either provided by a network, with which the device in the vehicle communicates with a server, or stored in media already situated in the vehicle.

Another example of a driver information system provides for access to a digital road map with information about particular objects in the vehicle surroundings, and with a heads-up display (HUD) system for contact-analogous, location-precise depiction of the particular objects. The information about the particular objects can be output audibly, in which the an audible output is correlated with a visual output, the position display on the HUD system in question. This allows the driver to assign the audio output of the applicable optical position display. The output of the visual or optical information is synchronously coupled with the audible output via the vehicle loudspeaker system. All the relevant information about the particular objects is provided by the system that provides information, for example a navigation system with a data bank or corresponding connection to the Internet, as well as it being received and continuously processed by the system.

In-car media systems may be equipped with handsets for reproduction by media products, in which features with informational and entertainment formats are combined. Because interacting with the handsets may require attention, these may not be suitable for driver entertainment.

In another example, detecting driver fatigue or a driver falling asleep may be provided. This detection may be provided without abrupt and disturbing visual or audible signals. Instead, information about sights or other diversions are provided by an in-vehicle GPS system, based on the current location of the vehicle.

For example, a touch screen or audible response may be provided that is interactive, and as such, may warn the driver about his/her condition. In order to determine the condition, questions are asked of the driver audibly. In another instance, an interactive game may be played, for instance, to determine the title of a song from song snippets. Information of interest to the driver is stored and is updated regularly.

The interactive system is either installed on the on-board computer or is controlled by a high-speed communications link, such as a cell phone, a wireless Internet connection, or satellite system (for example, a GPS system).

These systems are based on repetitive question-answer schemes, may not be equipped to work with several players or different languages. Static games exhibit the tendency to bore the player, due to a lack of a connection with a certain context. The questions are repeated, and as a result, become uninteresting.

### SUMMARY

A system is constructed so that an output of a location-dependent data from a data bank via the output unit, information received via an input unit, produces an output of the comparison results. Further, this system is developed as an interactive system. A moving object, i.e. a vehicle, may refer to the object associated with a position, and to whose position the location-dependent data refer.

In one example, the output unit is a display device. Further, the location-dependent data and the result of comparing the information received via the input unit may be output in a visual manner.

According to example, the output unit is configured to provide information audibly, for example, a loudspeaker system. At the same time, both the location-dependent data and the result of comparing the information received via the input unit with the location-dependent data can be audibly output.

The input unit may be a haptic unit, so that the information being received by the system can be input manually in response to the data output.

In another example, the input unit may be a microphone, or an electronic device capable of receiving sound information as an input. Thus, the information being received by the system in response to the data output may be input via sound.

According to another example, the data bank is constructed as an element of a server, in which the server includes a sending and receiving unit. Further, the object is constructed with a sending and receiving unit, which is in turn linked to the operating unit. The sending and receiving unit of the server is constructed with the sending and receiving unit of the object (for example, with a wired or wireless connection), so that the object is bi-directionally linked to the server.

The server is configured to receive the object's position transmitted by the operating unit, via the sending and receiving unit, to retrieve from the data bank location-dependent data corresponding to the position, and to send the location-dependent data via the sending and receiving unit to the operating unit.

The data concerning the position of the object, the location-dependent data, and the information received in response to the location-dependent data output can preferably be received, transmitted, or output in real time.

Real-time is defined as the data and information being operationally ready, so the data and information may be available and processed within a pre-determined time span. The system ensures that no delays occur which prevent adhering to this condition. Furthermore, the receipt, processing, and output of the data take place within the time required for the particular use. The entire processing of the data runs almost simultaneously with the corresponding processes.

An advantage, is that the object whose position is to be determined and to whose position the location-dependent data relates to (otherwise known as the “moving object”), enables the employment in a vehicle, such as a motor vehicle, a bicycle, aircraft, ship, or even for pedestrians.

The method according to aspects disclosed herein, includes:
determining the position of an object and sending the object's position to an operating unit,
receiving from a data bank location-dependent data corresponding to the position of the object, and sending the data to an operating unit,
sending the location-dependent data from the operating unit to an output unit and outputting the location-dependent data by means of the output unit,
receiving information in response to the data output via an input unit and sending the information received to the operating unit,
comparing the information received with the location-dependent data from the data bank, and
sending the results of the comparison from the operating unit to the output unit and outputting the result of the comparison via the output unit.

According to another example, the method may include:
sending the position of the object via the operating unit to a server,
the server receiving the object position sent by the operating unit,
receiving from the data bank the location-dependent data corresponding to the object position, and
sending the data to the operating unit.

The method may occur in real-time. The following may occur as a result
increasing the attention as well as the concentration of the driver,
preventing boredom during long trips with monotonous tasks and thereby increasing safety as opposed to other users of the road,
a situational link to the distinctive features of locations as geographic positions at which the vehicle and with it the passengers are found at the current point in time,
producing a feeling of “being educated” and of improving one's knowledge about the surroundings, which brings about lessons learned and with it, satisfaction,
interaction and data exchange between system and passengers in the vehicle, based essentially on audio reproduction, which minimizes the attention the system needs from the driver, and as a result, and
providing a simple operation of the system.

### DESCRIPTION OF THE DRAWINGS

FIG. 1 illustrates an example of an object (e.g. a motor vehicle) linked across a system according the aspects disclosed herein;

FIG. 2(a) illustrates an example of the system as a block diagram with an external and remotely disposed server and data bank;

FIG. 2(b) illustrates an example of the system as a block diagram with an external and remotely disposed server and internal data bank;

FIG. 2(c) illustrates an example of the system as a block diagram with an internal data bank; and

FIG. 3 is an illustration of a display device with display of the vehicle in relation to geographic locations as the vehicle surroundings and data for a location of interest proximal to the vehicle.

### DETAILED DESCRIPTION

The aspects disclosed herein provide for a system that increases the attention of an operator of a moving object, as well as the concentration of the operator. The system stimulates the mind, particularly during long trips with monotonous tasks, and thereby prevents boredom from occurring. Due to its implementation, the attention the driver pays to the system will be minimal. At the same time, a feeling of “being educated” and of improving one's knowledge about the surroundings can be produced with the system, which brings about lessons learned and with it, satisfaction.

The task according to the invention is resolved by means of a system for processing data for an object, as well as for the receipt, output, and comparison of information. The system exhibits an operating unit, a data bank for storing location-dependent data, a unit for determining the position of the object, an output unit for the output of location-dependent data, and an input unit for the input of information in response to the data output.

According to the aspects disclosed herein, an operating unit is configured so that a position of the object is received by the unit for determining the object's position, location-dependent data corresponding to the position is retrieved from a data bank, and both are output via the output unit. The operating unit is configured to receive information entered via an input unit, to compare it with the location-dependent data from the data bank, as well as to output the result of the comparison via the output unit.

Data is processed for the object, and allows for the receipt, output, and comparison of information, for example, via a processor. The system includes an operating unit, a data bank to store location-dependent data, a component for determining the position of the object, an output unit for the output of the location-dependent data, and an input unit for receiving information in response to the data output.

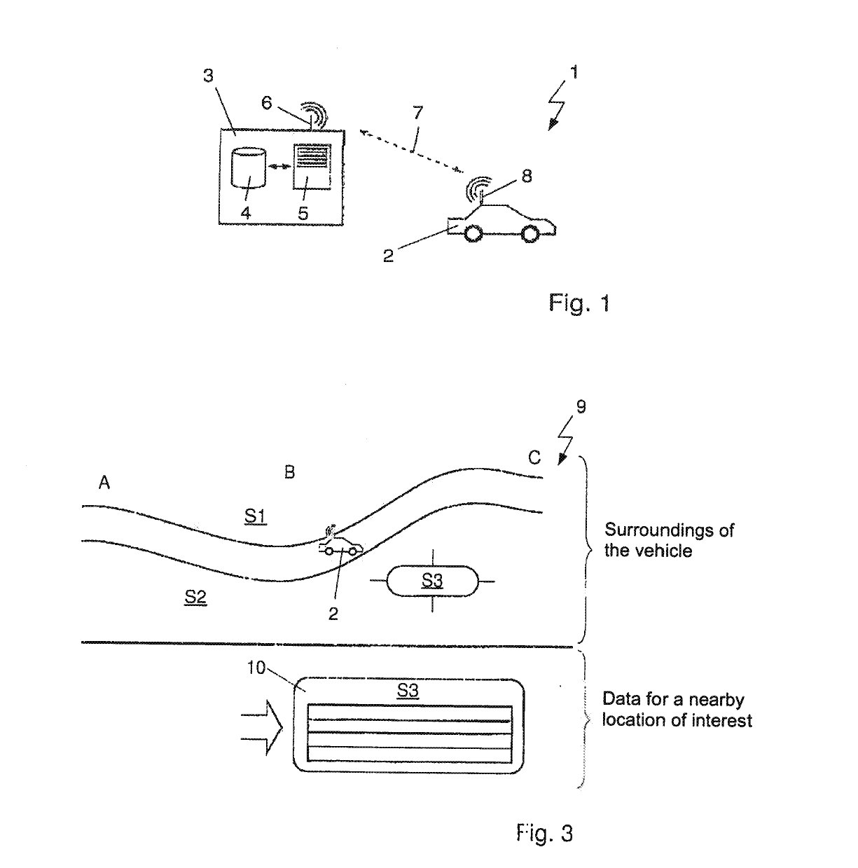

FIG. 1 illustrates an example of an object (e.g. a motor vehicle) linked across a system according the aspects disclosed herein. Referring to FIG. 1, a vehicle 2 driven by a driver, linked across a system 1 is shown. System 1 includes a server 3, for example for receipt, processing, storage, and comparison, as well as for sending of relevant data and information. Server 3 may obtain relevant parameters, such as location, for the vehicle 2.

Server 3 includes a data bank 4 and a master computer 5, which is also called the host. The data bank 4 may be any data storage device known to electrically store information, in a volatile or non-volatile fashion. The data bank 4 and master computer 5 are linked to each other for communication. Server 3 may include a sending and receiving unit 6, with which it communicates through a wireless link 7 with a sending and receiving unit 8 of vehicle 2. The server 3 may communicate in a wired fashion as well (not shown). The sending and receiving unit 8 of vehicle 2 sends vehicle-specific data, parameters, and information to the sending and receiving unit 6 of server 3, which receives the data. Sending and receiving unit 6 of server 3, in turn, sends processed data and information from the master computer 5 connected to data bank 4 to sending and receiving unit 8 of vehicle 2, which receives these data. Consequently, vehicle 2 is linked bi-directionally with the central server 3.

Server 3 is shown with the individual components at a fixed location. Alternatively, server 3 can also be constructed so that the components work remotely with each other.

The data could advantageously be prepared for the Internet and be made available over the Internet.

The data provided by server 3 and for vehicle 2 are transmitted by a network, such as a wireless network, radio network, or any sort of network that facilitates remote interaction. For example, conventional radio-transmission technology can be used, such as a cell phone or a wireless Internet connection. When provided via the Internet, the mobile unit of vehicle 2 is linked to the server 3. A device disposed in vehicle 2 communicates over the radio network with server 3 and transmits the relevant data.

The geographic position of vehicle 2 may be derived from a satellite-supported positioning system (i.e. GPS), and may already be included as part of a vehicle navigation system. The information pertaining to the position may be supplied to server 3.

Alternatively, the system may also be installed on an operating unit disposed in vehicle 2, for instance as an on-board computer, with the information stored in an in-vehicle system with a data bank.

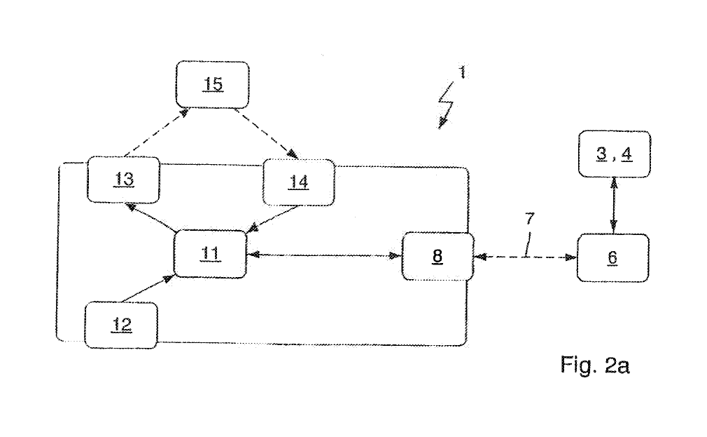

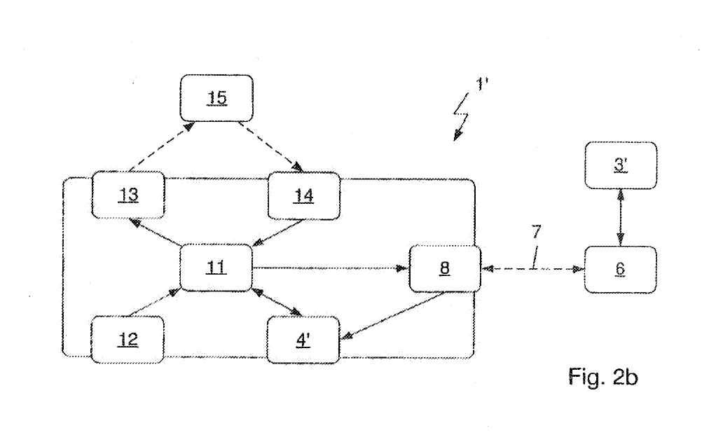

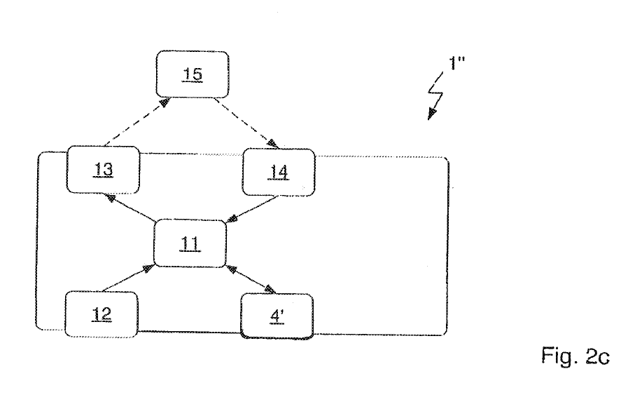

FIGS. 2(a)-(c) illustrate an example of the system as a block diagram with various configurations. Referring to FIGS. 2(a)-(c), a system 1, 1′, 1″ are shown as a block diagram. FIG. 2a shows system 1 with an external and remotely disposed server 3 linked to a likewise external and remotely disposed data bank 4. System 1′ results from FIG. 2b with an external and remotely disposed server 3′, but with a data bank 4′ internal to the vehicle. FIG. 2c shows system 1″ with an in-vehicle data bank 4′, with no link to a server.

System 1 from FIG. 2a corresponds to system 1 from FIG. 1. Server 3 with data bank 4 is constructed with a sending and receiving unit 6, with which it communicates over a wireless link 7 with the sending and receiving unit 8 of vehicle 2. Sending and receiving unit 8 of vehicle 2 is in turn connected to operating unit 11, which receives data on the current position of vehicle 2 from a unit 12 for determining position, such as a satellite-supported positioning system.

The position of vehicle 2 received from operating unit 11 is transmitted by the sending and receiving unit 8 of vehicle 2 to the sending and receiving unit 6 of server 3. The data output from data bank 4 for bits of information about the surroundings of vehicle 2 are transmitted by sending and receiving units 6, 8 to operating unit 11.

Operating unit 11 is connected to an output unit 13, and transmits the bits of information, for example, in the form of a question, audibly or visually, into the passenger compartment, so that the question can be noted by driver 15 or passenger 15. The answer to the question is in turn supplied to system 1 via input unit 14, which transmits it to operating unit 11. After comparing the answer with the question, operating unit 11 outputs a response via output unit 13 as to whether the question has been answered correctly or not.

In contrast to system 1 from FIG. 2a, system 1′ from FIG. 2b exhibits an in-vehicle data bank 4′ instead of a data bank 4 that is disposed remotely from vehicle 2. What is more, operating unit 11 is direct, that is, without a link through a server 3′, and is bi-directionally in contact with data bank 4′.

The value received by operating unit 11 via unit 12 for determining the position of vehicle 2 is transmitted by sending and receiving units 8, 6 to server 3′, which is likewise connected via sending and receiving units 6, 8 to data bank 4′. Data bank 4′ obtains the data transmitted by server 3′ via sending and receiving units 6, 8.

Communication of system 1′ with the driver 15 or passengers 15 takes place as described for system 1 from FIG. 2a.

In contrast to system 1 from FIG. 2a, system 1″ from FIG. 2c exhibits an in-vehicle data bank 4′ instead of a data bank 4 remotely disposed from vehicle 2 and exhibits no link to a server. Operating unit 11 is direct and bi-directionally in contact with data bank 4′.

The value received by operating unit 11 via unit 12 for determining the position of vehicle 2 is processed by operating unit 11 itself and is transmitted to data bank 4′, which in turn transmits the location-specific bits of information in the form of questions to operating unit 11.

System 1″ communicates with driver 15 or passengers 15 like system 1 from FIG. 2a.

FIG. 3 is an illustration of a display device with display of the vehicle in relation to geographic locations as the vehicle surroundings and data for a location of interest proximal to the vehicle. Referring to FIG. 3, a display device 9 with the display of vehicle 2 in relation to various geographic towns A, B, C and locations of interest S1, S2, S3 found in the surroundings of vehicle 2, as well as data as information for a nearby location of interest S3 is shown. Moreover, vehicle 2 moves from town A, past town B in the direction of town C, and has already passed locations of interest S1 and S2.

The current position of vehicle 2 is detected via in-vehicle unit 12, as a satellite-supported positioning system belonging to the navigation system; and is subsequently sent to one of servers 3, 3′ and received by servers 3, 3′, or it is processed by the in-vehicle system. Geographic towns A, B, C, as well as further locations of interest S1, S2, S3 in the surroundings of vehicle 2 are determined through servers 3, 3′ or the in-vehicle system or data banks 4, 4′. Further, information on the closest location of interest S3 is simultaneously generated. The information for deployment is accessed in data banks 4, 4′. The data produced by servers 3, 3′ are sent to vehicle 2 and received by vehicle 2.

The information generated by servers 3, 3′ or the in-vehicle system is depicted by means of display device 9. When transmitting data in real time or near-real time, the place is displayed where vehicle 2 is found at the current point in time.

Questions, as well as applicable correct and optionally incorrect answers for locations of interest S1, S2, S3 are stored in data banks 4, 4′. Filtered questions are posed by systems 1, 1′, 1″ for the passengers, particularly the driver, of vehicle 2 based on the present geographic position of vehicle 2. Information 10 for the closest location of interest S3 is either depicted on display device 9, on which information 10 can also include specific questions on the closest location of interest S3, or the questions are output via the loudspeaker system of vehicle 2. The output of information 10 can alternatively also take place via both display device 9 and the loudspeaker system. Systems 1, 1′ 1″ consequently communicate with the driver or passengers in an visual or audible manner.

If, for example, Brookline has been detected as the closest location of interest S3, a question could be posed by systems 1, 1′, 1″ to read as follows: “Which President was born on 29 May 1917 in Brookline?”. After a prompting with the answers “(A) Barak Obama, (B) Charlie Chaplin, or (C) J. F. Kennedy”, the passenger of vehicle 2 transmits his/her answer, for example “(B)”. The passenger's answer is compared in systems 1, 1′, 1″ with the correct answer and the result of the comparison is output, in the present case, for instance, with: “Unfortunately, that is wrong”. An interaction between systems 1, 1′, 1″ and the driver could be characterized by questions with several possible answers or also, alternatively, by simple questions with no pre-defined answer.

The driver or the passenger enters his/her answer to the question posed by systems 1, 1′, 1″ or for a question being answered, for instance with haptic units such as push-buttons, keys, or switches, a keyboard, a touch screen, or similar units, in systems 1, 1′, 1″. Alternatively, entering the answer can also take place via acoustic units such as a microphone; the answer is spoken.

The questions can be answered by a single passenger in vehicle 2 as well as by several, so that the passengers could compete with one another. With several passengers answering, the individual participants are identified by acoustic input through speech recognition.

We claim:

1. A system for providing real-time, location-dependent entertainment, comprising:
a location receiver to receive a position associated with an object, the object being a moving vehicle;
a data receiver to receive location-dependent data based on the position via a data bank;
an input receiver to receive an input from an operator in the object;
a data transmitter to transmit the received input to a server associated with the data bank, wherein the server is configured to provide receive the input, and process an answer; and
a data receiver to receive the answer.

2. The system according to claim 1, further comprising an output unit.

3. The system according to claim 2, wherein the output unit is configured to display the answer.

4. The system according to claim 2, wherein the output unit is configured to audibly output the answer.

5. The system according to claim 1, wherein the input is configured to be a haptic input receiver.

6. The system according to claim 1, wherein the input is configured to be a microphone.

7. The system according to claim 1, wherein the location-dependent data corresponds to the position being correlated to a geographical location of the object.

8. The system according to claim 7, wherein the location-dependent data is a question associated with the geographical location.

9. A method for providing real-time, location-dependent entertainment, comprising:
determining a position of an object and sending the object's position to an operating unit;
receiving from a data bank the location-dependent data corresponding to the object position, and sending the location-dependent data to operating unit;
sending the location-dependent data from the operating unit to an output unit, and outputting the location-dependent data via the output unit;
receiving information in response to the data output via an input unit and sending the information received to operating unit;
comparing the information received with the location-dependent data from the data bank, and sending a comparison result from operating unit to the output unit; and
outputting the result of the comparison via the output unit.
